(19) United States
(12) Patent Application Publication
(10) Pub. No.: US 2012/0163120 A1
(43) Pub. Date: Jun. 28, 2012

(54) PASSIVE NOISE CANCELLING PIEZOELECTRIC SENSOR APPARATUS AND METHOD OF USE THEREOF

(76) Inventor: Richard E. Pearce, Weatherford, TX (US)

(21) Appl. No.: 13/337,091

(22) Filed: Dec. 24, 2011

Related U.S. Application Data
(63) Continuation-in-part of application No. 13/295,356, filed on Nov. 14, 2011.
Application No. 13/295,356 is a continuation-in-part of application No. 13/295,380, filed on Nov. 14, 2011.
Application No. 13/295,380 is a continuation-in-part of application No. 13/295,402, filed on Nov. 14, 2011.
(60) Provisional application No. 61/427,775, filed on Dec. 28, 2010.

(51) Int. Cl. G01V 1/38; H04R 17/00

(52) U.S. Cl. 367/21; 367/157

(57) ABSTRACT

Sensors used in mapping strata beneath a marine body and/or structures on a marine body floor are described, such as in a flexible buoyancy adjustable towed array. A first sensor is a traditional acoustic sensor or a novel acoustic sensor using a piezoelectric sensor mounted with a thin film separation layer of flexible microspheres on a rigid substrate. Additional non-acoustic sensors are optionally mounted on the rigid substrate for generation of output used to reduce noise observed by the acoustic sensors. Combinations of acoustic, non-acoustic, and motion sensors co-located in rigid streamer housing sections are provided, which reduce noise associated with different sensor locations and/or localized turbulence.

### CROSS-REFERENCES TO RELATED APPLICATIONS

This application is:
a continuation-in-part of U.S. patent application no. 13/295,356 filed Nov. 14, 2011;
a continuation-in-part of U.S. patent application no. 13/295,380 filed Nov. 14, 2011;
a continuation-in-part of U.S. patent application no. 13/295,402 filed Nov. 14, 2011; and
claims the benefit of U.S. provisional patent application No. 61/427,775 filed Dec. 28, 2010,
all of which are incorporated herein in their entirety by this reference thereto.

### TECHNICAL FIELD OF THE INVENTION

The present invention relates to use of noise cancelling sensors to determine positions of objects about a body of water.

### DESCRIPTION OF THE RELATED ART

Towed arrays of hydrophone sensors are used to map strata beneath large bodies of water, such as gulfs, straights, and oceans.

Patents related to the current invention are summarized herein.

### Streamer Cable

R. Pearce, “Non-Liquid Filled Streamer Cable with a Novel Hydrophone”, U.S. Pat. No. 5,883,857 (Mar. 16, 1999) describes a streamer cable including a plurality of serially coupled active cable sections having hydrophones located within an outer jacket and a longitudinally and centrally located electro-mechanical cable.

R. Pearce, “Non-Liquid Filled Streamer Cable with a Novel Hydrophone”, U.S. Pat. No. 6,108,267 (Aug. 22, 2000) describes a towed array having a central strain member, an inner protective jacket about the strain member, a foam material about the inner protective jacket, and a potting material bonded to the inner protective jacket inside an outer protective jacket.

R. Pearce, “Method and Apparatus for a Non-Oil-Filled Towed Array with a Novel Hydrophone and Uniform Buoyancy Technique”, U.S. Pat. No. 6,498,769 B1 (Dec. 24, 2002) describes a towed array having uniform buoyancy achieved using hollow microspheres in a polyurethane matrix, where the percentage of hollow microspheres is correlated with adjacent density of elements of the towed array.

R. Pearce, “Acoustic Sensor Array”, U.S. Pat. No. 6,614,723 B2 (Sep. 2, 2003) describes an acoustic sensor array having buoyant sections formed using reaction injection molding with controlled and varying amounts of hollow microspheres and polyurethane as a function of position on the array.

### Sensor

R. Pearce, “Acoustic Transducer”, U.S. Pat. No. 5,357,486 (Oct. 18, 1994) describes a piezoelectric film strip wrapped around a mandrel having stand off collars on each end. Variations in hydrodynamic pressure flex the film strip in tension to generate a voltage.

R. Pearce, “Acoustic Sensor”, U.S. Pat. No. 5,361,240 (Nov. 1, 1994) describes an acoustic sensor having a hollow mandrel with an outer surface defining a concavity and a flexible piezoelectric film wrapped about the outer surface forming a volume between the film and the mandrel, the volume serving as a pressure compensating chamber.

R. Pearce, “Acoustic Sensor and Array Thereof”, U.S. Pat. No. 5,774,423 (Jun. 30, 1998) describes an acoustic sensor having electrically coupled piezoelectric materials.

R. Pearce, “Acoustic Sensor and Array Thereof”, U.S. Pat. No. 5,982,708 (Nov. 9, 1999) describes an acoustic sensor having a substrate with a concavity on an outer surface that is sealingly enclosed by an active member of a piezoelectric material.

R. Pearce, “Acoustic Sensor and Array Thereof”, U.S. Pat. No. 6,108,274 (Aug. 22, 2000) describes an acoustic sensor having a mandrel, a first substrate on an outer surface of the mandrel, a damping layer between the first substrate and a second substrate, a piezoelectric sensor mounted to the second substrate, and an encapsulating material on the piezoelectric material.

R. Pearce, “Method and Apparatus for a Non-Oil-Filled Towed Array with a Novel Hydrophone and Uniform Buoyancy Technique”, U.S. Pat. No. 6,819,631 B2 (Nov. 16, 2004) describes a towable hydrophone having a diaphragm with a tubular shape, a thin film piezoelectric element attached to the diaphragm, the diaphragm having a back plane having a cylindrical shape, and at least one longitudinal rib on the exterior of the back plane, where the back plane and exterior rib slidingly engage the tubular diaphragm.

### Problem Statement

What is needed is one or more sensors for use in mapping objects or features under a water body having increased insensitivity to noise sources and enhanced band width.

### SUMMARY OF THE INVENTION

The invention comprises a piezoelectric sensor method and apparatus.

### BRIEF DESCRIPTION OF THE DRAWINGS

A more complete understanding of the present invention is derived by referring to the detailed description and claims when considered in connection with the Figures, wherein like reference numbers refer to similar items throughout the Figures.

FIG. 1 illustrates a towed sensor array;

FIG. 2 figuratively illustrates motion localized turbulence about a sensor;

FIG. 3 presents an acoustic sensor using microspheres, FIG. 3A, and the acoustic sensor in cross section, FIG. 3B;

FIG. 4 represents an electrically coupled acoustic sensor and non-acoustic sensors; and

FIG. 5 illustrates multiple closely spaced sensor types on a substrate of a towable array.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

The invention comprises a noise cancelling piezoelectric sensor apparatus and method of use thereof.

In one embodiment, an acoustic sensor is provided having a piezoelectric sensor coupled with a microsphere loaded transfer adhesive as a compressible gas chamber.

In another embodiment, multiple sensor types are co-positioned for use in removal of noise from turbulence.

In still yet another embodiment, a piezoelectric element is motion restricted in one or more dimensions to enhance sensitivity and/or to select sensitivity.

In one example, the system includes two piezopolymer thin film elements configured in such a manner as to form a dedicated acoustic sensor and a dedicated flow noise cancelling acoustic sensor, both of which are excited by forces and in some cases substantially similar forces manifested as dynamic pressure with immunity to acceleration and dynamic particle motion with immunity to dynamic pressure so as to allow for the discreet measurement of acoustic energy and particle motion present at a single location or in a small volume, as described infra. The acoustic sensor being embodied in such a manner as to allow the inherent response characteristics of thin film polyvinylidene fluoride (PVDF) to sense both acoustics and noise produced by the turbulent boundary layer as dynamic pressure while simultaneously sensing only the turbulent boundary layer manifested as a response to a force, producing a response in the non-acoustic portion of the element to the turbulent boundary layer that is about one hundred eighty degrees out of phase with that detected on the acoustic portion of the element. This is accomplished in a single contiguous sensor mechanically constrained in such a way as to allow a portion of the element to respond to dynamic pressure and a portion of the element to respond only to mechanical force. A simple embodiment of this invention is presented with the sensor comprised of a single piece of PVDF film where a single strip of acoustic sensor is surrounded by two strips in corresponding force sensors. Complex patterns are also available to enhance the performance of the invention utilizing fractal pattern sampling of the turbulent boundary layer. The completed sensors are then used to construct a seismic streamer section necessarily of a solid construction where the sensors are placed.

### Axes

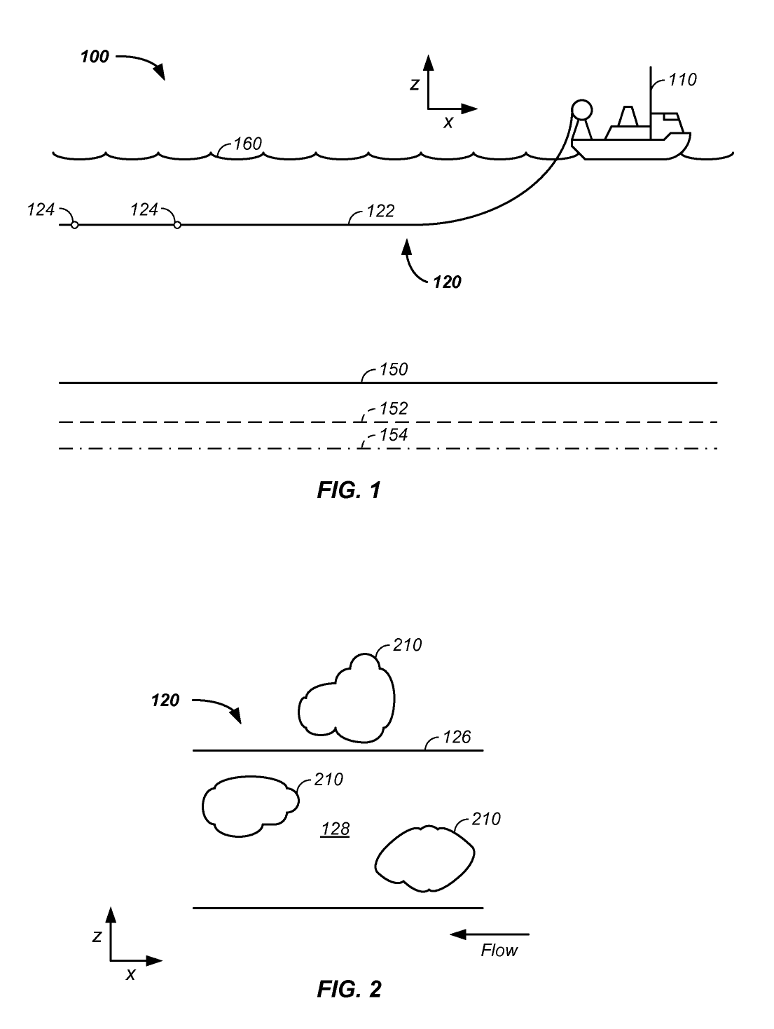

Referring now to FIG. 1, herein an x-axis is in a horizontal direction of towing of a sensor array. The x/y axes form a plane parallel to a water body surface. The z-axis is aligned with gravity. Typically, the thickness of a piezoelectric film is viewed in terms of a z-axis, though the piezoelectric film is optionally rolled about a mandrel, described infra.

### Piezoelectric Material

Piezoelectricity is charge that accumulates in certain solid materials in response to applied mechanical stress. A piezoelectric material generates electricity from applied pressure.

An example of a piezoelectric material is polyvinylidene fluoride (PVDF). Unlike ceramics, where the crystal structure of the material creates the piezoelectric effect, in the PVDF polymer intertwined long-chain molecules attract and repel each other when an electric field is applied.

The polyvinylidene material is particularly useful in aqueous environments as the acoustic impedance of PVDF is similar to that of water. An external mechanical force applied to a film of polyvinylidene fluoride results in a compressive or tensile force strain. A film of PVDF develops an open circuit voltage, or electrical charge, which is proportional to the changes in the mechanical stress or strain. By convention, the polarization axis is the thickness axis of the polyvinylidene material. Tensile stress may take place along either the longitudinal axis or the width axis.

Herein, for clarity, polyvinylidene fluoride is used as an example of the piezoelectric material. However, any material that generates a charge in response to pressure is optionally used. Examples include: man-made crystals, such as gallium orthophosphate, a quartz analogic crystal, and langasite; man-made ceramics, such as a titanate, a niobate, a tantalate, or a tungstate; and/or a lead-free piezoceramic.

A PVDF material is characterized in terms of a strip of PVDF film. The PVDF film includes a width axis or x-x axis, a length axis or y-y axis, and a thickness axis or z-z axis. The PVDF film x-x axis is less sensitive, in terms of developed charge, to applied forces than the length axis or the thickness axis of the PVDF film. Hence, in the sensors described herein, the width axis of the PVDF film is typically about parallel to the towing direction of the sensor array to minimize noise signals resultant from towing of the sensor array with a cable under varying strain. As described, infra, expansion of the y-y axis of the PVDF film is optionally restrained in a mounting step, which results in increased thickness changes of the PVDF film resultant from applied forces. The increased thickness change as a function of applied force is equivalent to an increased signal-to-noise ratio.

The PVDF film is optionally cut, shaped, or wrapped about a surface, such as a mandrel or hollow tube.

A PVDF sensor is a PVDF film coupled with at least one charge transfer element, such as a conductive wire. In one case, a PVDF sensor includes a PVDF film coated on both sides with a conductive ink. In a second case, the PVDF film is coated on one side with a conductive ink and the opposite side makes contact with a conductive fluid, as described infra, to form a PVDF sensor.

### Conditioning Electronics

Electric output from the PVDF sensor is carried along a conductive element, such as a wire, to an electrical circuit. The electrical circuit optionally includes: a current to voltage converter, such as a preamplifier, an amplifier, processing electronics, an analog-to-digital converter, and/or a data buss. Signal from a first PVDF sensor is optionally:
combined with signal from a second PVDF sensor using the on-board electrical circuit; and/or
is post processed after communication of the gathered signal to a processing center.

### Towed Sensor Array

Still referring to FIG. 1, a system for mapping strata 100 under a floor of a water body is illustrated. In the illustrated example, a vessel 110, such as a ship tows one or more sensor arrays 120. A sensor array 120 includes at least a streamer cable 122 and a sensor 124.

The streamer cable 122 optionally includes:
an outer housing 126;
a strain member 310, such as a central strain member;
a wire bundle configured to carry power and/or data, the wire bundle is preferably wrapped about or within the strain member to reduce strain from towing;
a plurality of sensors 124, such as about equispaced or not equally spaced hydrophones, non-acoustic sensors, and/or accelerometers;
electronics;
a buoyancy element; and/or
a protective jacket about the sensors, strain member, and wire bundle.

The sensors are further described, infra.

In one use, a seismic shock wave is generated, such as with an explosive. The shock wave partially reflects from a floor 150 of the water body, and/or from a series of strata layers 152, 154 under the water body floor 150. In one case, the surface reflections yield a vertically rising seismic wave 142 that strikes the one or more sensors 124. In a second case, a seismic wave at least partially reflects off of a water body surface 160 to yield a vertically descending seismic wave 144, which strikes the one or more sensors 124. The vertically descending seismic wave is an interference signal, which reduces the bandwidth and associated signal-to-noise ratio of the sensors 124.

In another use, the sensors 124 are used passively, such as without the use of a detonated explosive.

In any case, the sensors 124 are optionally configured to passively cancel noise, such as noise from localized turbulence.

Still referring to FIG. 1, those skilled in the art know that a sensor or a matrix of sensors may be used to map strata layers, and/or to detect underwater geophysical structures.

### Sensors

The sensors 124 are further described. Any of the sensors 124 described herein are optionally coated with a flexible solid material as part of the streamer 122. Further, sensors 124 are optionally positioned at any x-axis position of the streamer 122 to form the sensor array 120, though equispacing of like sensor elements 124 is preferable.

### Turbulence

Referring now to FIG. 2, localized turbulence bubbles 210 are figuratively illustrated. Some turbulence bubbles 210 interact with the outer housing 126 about a sensor 124. In same cases, the turbulence bubbles 210 have a localized impact on a first sensor not sensed by a second sensor. This difference in impacts allow signal and/or noise resultant from the localized turbulence to be removed, such as by passive removal and/or through post processing of data from the first sensor and the second sensor. In practice, any number of sensors are optionally used.

### Acoustic Sensor

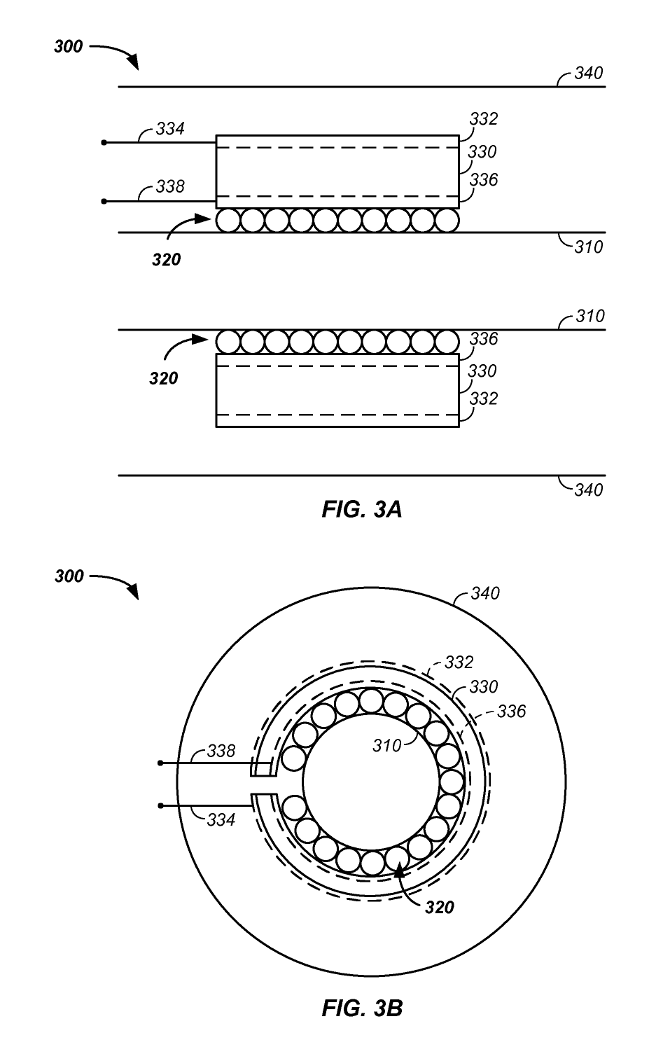

Referring now to FIG. 3A and FIG. 3B, an acoustic sensor 300 is illustrated.

The acoustic sensor uses a piezoelectric film, which is described herein as a piezoelectric acoustic film 330, which maintains the general properties of a piezoelectric material or element.

Still referring to FIG. 3A, the acoustic sensor 300 includes:
a substrate, 310;
a piezoelectric motion film 330 optionally attached to a diaphragm; and
a hollow cavity, hollow chamber, an enclosed chamber, and/or a set of microspheres 320 between the substrate 310 and the piezoelectric motion film 330.

Each of the acoustic sensor 300 elements are further described herein.

### Substrate

In practice, the substrate 310 is optionally a hollow tube or a hollow mandrel. The substrate 310 is sufficiently rigid to isolate internally radiated stresses from the embodied piezo elements in the acoustic sensor 300 described, infra. The substrate 310 optionally includes a concave inner surface, defining an inner wall of a tube. The tube is optionally used to contain and/or to constrain movement of centrally placed elements, such as a strain member of the streamer cable 122, the wire bundle configured to carry power and/or data, a shock absorbing element, and/or the electronics. The substrate 310 also optionally includes a convex outer surface upon which the sensor elements are mounted. The convex outer surface of the substrate 310 optionally contains an outer concavity or channel 405. The channel or cavity 405 is created either through machining or through a molding process by which the channel 405 is presented around a circumference located outside the rigid mandrel or substrate 310. Sensor elements are optionally located in the outer concavity or channel 405. For example, in one case the substrate 310 includes a pair of inner shoulders, which function as a mechanical support for a diaphragm and/or the piezoelectric motion film 330. The inner shoulders are either machined or molded and are located outside and to the side of the created channel at a depth and width sufficient to allow attachment of the piezofilm motion sensor element 330 forming a sealed chamber between the piezofilm and the substrate 310. Optionally, the acoustic sensor 300 includes an outer acoustic sensor housing. The outer acoustic sensor housing or second rigid cylindrical mandrel is positioned over a cavity formed by the outer shoulders thus sealing the entire acoustic sensor 200 inside. The outer acoustic sensor housing prevents the acoustic sensor 300 from responding to dynamic pressure. Further, the outer acoustic sensor housing forms an outer mandrel upon which an outer passive flow noise cancelling acoustic sensor is optionally positioned. Preferably, the outer motion sensor housing is rigid or semi-rigid. The outer motion sensor housing is optionally connected to the substrate 310, such as through a pair of outer shoulders positioned along the x-axis further from a center of the enclosed chamber 405 relative to the inner shoulders. The additional set of outer shoulders adjacent and outside the inner shoulders optionally form a second chamber above the first thin film piezoelectric element. Both the inner and outer shoulders are optionally a part the substrate 310, are removable elements affixed to the substrate 310, are affixed to the acoustic sensor housing, and/or are part of the acoustic sensor housing.

In one example, the piezoelectric acoustic film 330 is mounted radially outward from the substrate 310 in a manner forming a sealed hollow chamber or layer of microspheres 320 therebetween, as described infra. For example, the piezoelectric polymer thin acoustic film element 330 is constructed with a deposited single electrode on the outer surface so as to create a continuous electrode around the circumference of the resulting piezofilm cylinder created when the film is attached to the shoulders previously described and sealed where the film wrap overlaps or meets creating a hollow and sealed chamber between the piezoelectric acoustic film 330 and the substrate 310 within the channel 405. For example, the piezoelectric motion film 330 is mounted over a portion of the outer concavity or channel of the substrate 310 or is mounted directly or indirectly to the inner shoulders. The piezoelectric motion film 330 optionally forms one or more layers circumferentially surrounding the substrate 310. The hollow chamber extends to at least partially circumferentially encompass an x-axis section of the substrate 310. In one case, the piezoelectric film mounts directly to the substrate 310, such as by mounting to the inner shoulders of the substrate 310. Mechanically affixing, such as with a wrap and/or an adhesive, the piezoelectric acoustic film 330 to the inner shoulders restricts movement of the y-y axis of the piezoelectric film. The restricted y-y axis motion of the piezoelectric motion film 220 and the orientation of the x-x axis of the piezoelectric film along the x-axis or towing axis results in enhanced changes in the z-z thickness axis of the piezoelectric film as a response to pressure/size changes resultant from seismic waves or a noise source, which increases the signal-to-noise ratio of the acoustic sensor 300. The x-x axis edges of the piezoelectric acoustic films are similarly optionally restrained, which again increases the signal-top-noise ratio of the acoustic sensor. In additional cases, the piezoelectric acoustic film 330 is indirectly affixed to the substrate 310, such as through the use of a diaphragm. In all such cases, at least a portion of the hollow chamber is physically positioned between the substrate 310 and the piezoelectric acoustic film 330.

Changes in thickness of the piezoelectric acoustic film 330, which is proportional to the changes in the mechanical stress or strain resulting from the seismic wave or noise source, is measured using electrical connections to the piezoelectric acoustic film 330. A first electrical connection 334 is made to an outer surface or radially outward surface of the piezoelectric acoustic film 330 using conductive material, such as a flexible conductive ink 332, applied to the outer surface of the piezoelectric film 330. For example, a wire is attached by suitable means to the plated outer electrode or conductive ink 332 of the piezoelectric acoustic film 330 and passed through the outer shoulders, where the wire is connected to signal wires of the acoustic sensor 300. A second electrical connection 338 to at least a portion of a radially inner surface of the piezoelectric acoustic film 330 is made, such as with a metalized ink or conductive fluid. The open circuit voltage, or electrical charge, of the piezoelectric acoustic film 330, which is proportional to the changes in the mechanical stress or strain, is measured using the electrical signal carried by the conductive ink layers 332, 334 and the electrical leads 334, 338. For example, the electrical lead is an electrically conductive wire or sheet adhered to the outer diameter of the hollow chamber so as to form a conductive surface or electrode using a stable metallic material. In a case where wire is used, the wire is optionally wrapped a plurality of turns around the circumference of the substrate 310 so as to create a continuous conductive path around the circumference passing the wire from the inside of the piezoelectric film 330 to the outside of the hollow chamber through a hole in the inner shoulder, which is preferably later sealed. As the external hydrostatic pressure increases or decreases, resultant from the seismic wave or turbulence bubble 210, contraction or expansion of the substrate 310 and/or diaphragm to which the substrate is optionally mounted results in corresponding contraction or expansion of the hollow chamber, the diaphragm, the piezoelectric acoustic film 330, and/or an array of flexible microspheres, described infra. Changes in the piezoelectric acoustic film 330, such as in the z-z thickness axis, are measured using the first electrical connection 334 made to the conductive ink on one side of the piezoelectric acoustic film 330 and the second electrical connection 338 using the electrical lead contacting the opposite side of the piezoelectric film 330.

### Microspheres

Still referring to FIG. 3A and FIG. 3B, in this example the acoustic sensor uses an array of flexible microspheres. In this example, a piezoelectric acoustic film 330 is wrapped about the mandrel 310. The piezoelectric acoustic film 330 includes conductive material 332, 336 on the outer surface and the inner surface, respectively. For example, a first electrical connector 334 is connected to a first flexible conductive ink circuit on the outer surface of the piezoelectric acoustic film 330. Similarly, a second electrical connector 338 is connected to a second flexible conductive ink circuit on the inner surface of the piezoelectric acoustic film 330. A set of flexible microspheres 320 are positioned between the mandrel 310 and the inner layer 336 of the piezoelectric acoustic film 330. The outer surface of the piezoelectric acoustic film 330 is optionally coated or contained within a flexible solid 340.

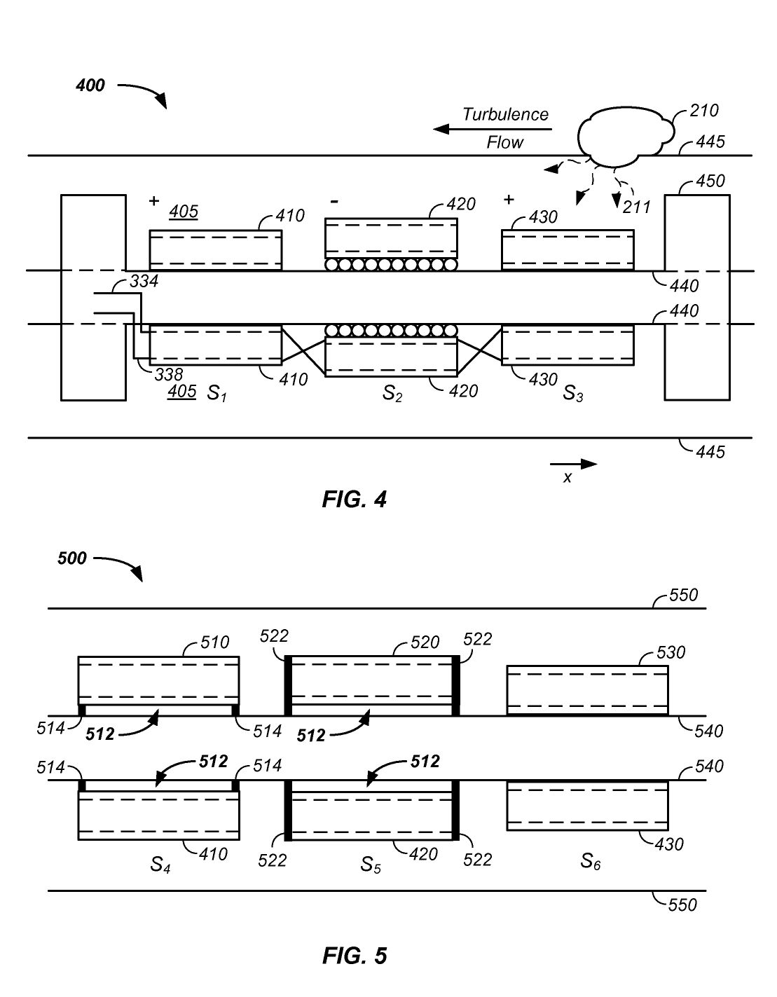

Referring now to FIG. 4, the microspheres 320 are responsive to pressure and mechanically isolate the piezoelectric acoustic film 330. For example, if the acoustic sensor 300 is mounted on a structure that is struck, the microspheres 320 isolate the piezoelectric acoustic film 330 of the acoustic sensor 300 from the transmitted energy in the structure. Similarly, the microspheres 320 isolate mechanical motion resulting from a turbulence bubble for the piezoelectric film 330. Conversely, adjacent sensors, such as sensor 1 and sensor 3, described infra, that do not have the isolating microspheres respond to or sense turbulence bubbles 210.

The set of microspheres 320 is optionally a single layer of microspheres or a thickness of microspheres 320, such as less than about 10, 20, 30, 40, 50, 60, 70, 80, 90, 100, 150, 200, 300, 500, 1000, 5000, or 10,000 micrometers thickness. The average diameter of the microspheres 320 is less than about 1, 2, 5, 10, 20, 50, 100, or 1000 micrometers.

The microspheres 320 are generally flexible, are preferably plastic, and are not to be confused with incompressible glass spheres used for buoyancy control, such as in the outer member 445.

The microspheres 320 in the hydrophone sensor 300 are optionally flexible and/or plastic. In the piezoelectric acoustic sensor 300 or hydrophone, the compressible microspheres 320 are optionally placed into and/or onto an adhesive material, such as to form an adhesive strip or a sphere coated and/or impregnated transfer adhesive. For example, the transfer adhesive is optionally a flexible layer, polymer, or tape coated on preferably one side and optionally both sides with a layer of the flexible microspheres 320. The flexible microspheres on and/or in the transfer adhesive are wrapped about the rigid surface or mandrel, or rigid motion sensor housing 240. Preferably, the microspheres 320 are coated onto a surface of the transfer adhesive and the sphere coated surface of the transfer adhesive is wrapped about the rigid acoustic sensor mandrel 440 to form a layer of flexible microspheres 320 on the inner surface of the piezoelectric polymer acoustic film 330 circumferentially wrapped on the rigid substrate or mandrel 440.

The thin film piezoelectric acoustic sensor 300 optionally uses a flexible microsphere loaded adhesive transfer material, which is applied to one side of the plated film along a length from the end equal to the circumference of the outer mandrel 310. Optionally, the microsphere loaded adhesive material, as part of the piezoelectric acoustic sensor 300, is positioned between two adjacent strips of non-sphere loaded adhesive forming non-acoustic sensors, as described infra.

In practice, an acoustic pressure wave is converted to a mechanical motion 211 at the water/flexible solid interface. The mechanical motion is transferred to the piezoelectric acoustic film 330, where a change in shape of the piezoelectric acoustic film 330 is picked up as a corresponding electrical signal using the first electrical connector 334 connected to the first flexible conductive ink circuit on the outer surface of the piezoelectric acoustic film 330 and the second electrical connector 338 of the second flexible conductive ink circuit on the inner surface of the piezoelectric acoustic film 330. The electrical signal is amplified and processed, as described supra, to yield information on the seafloor structure, floor 150 of the water body, and/or on the series of strata layers 152, 154 under the water body floor 150.

### Multiple Sensors

Multiple sensors are optionally used in each sensor section of the sensor array 120. For example, output from one or more motion sensor is combined with output from one or more acoustic sensor 300, output from a first motion sensor is combined with output from a second motion sensor, output from a first acoustic sensor is combined with output from a second acoustic sensor, and/or output from an acoustic sensor is combined with output from a non-acoustic sensor. The process of combining the signals optionally occurs passively using electrical connections, in a pre-processing stage by use of electronic circuitry, and/or occurs in a post-processing digital signal processing process.

Referring now to FIG. 4, an example of a first multiple sensor system 400 is illustrated. In this example, a central member 440 is encased in an outer element 445, such as a buoyancy element. As a function of x-axis position, three sensors (S₁, S₂, and S₃) are figuratively illustrated. The first sensor 410 and the third sensor 430 are each independently functioning non-acoustic sensors using a piezoelectric film and associated electrical connection layers applied directly to the central member 440. The second sensor 420 contains substantially the same features as the first sensor 410 except the piezoelectric film and associated electrical connection layers are separated from the central member by at least one layer of hollow spheres, such as the flexible microspheres 320, forming an acoustic sensor as described supra. One or more of the edges and/or ends of the piezoelectric film of the second sensor 420 are optionally constrained, as described infra. As illustrated, the first sensor 410, second sensor 420, and third sensor 430 are optionally electrically connected to allow for direct subtraction of signal observed by the non-acoustic sensors 410, 430 from signal observed by the acoustic sensor 420. Optionally, the individual signals from each sensor are collected and are later processed. Since the outer element dampens mechanical motion 211 from the turbulence bubble 210, a localized mechanical disturbance can be observed with one of the three sensors 410, 420, 430 while not being observed by a second of the three sensors 410, 420, 430.

Referring now to FIG. 5, an example of a second multiple sensor system 500 is illustrated. In this example, a central tube 540, such as a rigid tube, is encased in an outer housing 550, such as a semi-flexible housing. As a function of x-axis position, three sensors (S₄, S₅, and S₆) are figuratively illustrated. The fourth sensor 510 uses a diaphragm 512 between the central tube 540 and the piezoelectric sensor elements of the inner and outer conductive layers on opposite sides of the piezoelectric film. The diaphragm 512 is offset from the inner tube 440 by use of offset elements 514, such as the inner shoulders described supra. The fifth sensor 520 contains the same features as the fourth sensor 510 except that one or more of the edges 522 of the piezoelectric film are constrained, such as with an adhesive or wrap, causing enhanced deformation along the z-z axis of the piezoelectric film yielding an enhanced signal-to-noise ratio, as described supra. The sixth sensor 530 also uses a piezoelectric film between two metal layers, however, the third sensor is bonded directly to the inner tube 540 yielding a non-acoustic sensor. The diaphragm 512 or gap optionally contains an array of flexible microspheres.

Still referring to FIG. 5, the fourth, fifth, and sixth sensors 510, 520, and 530 are positioned in about the same position on the streamer cable 122, such as within about 1, 2, 3, 5, 10, or 20 centimeters of each other. The close proximity of the three sensors 510, 520, and 530 allows each of the three sensors 510, 520, 530 to observe the same pseudo random turbulence anomalies, which are localized in space at a given time. By comparing output signals from the three sensors 510, 520, 530, noise is reduced. For example, the fourth sensor 510 and the fifth sensor 520 each observe acoustic signal, such as from the shock wave, while the sixth sensor 530 observes local turbulence phenomenon also observed by the first sensor 510 and the second sensor 520. By subtracting or mathematically removing the signal observed by the sixth sensor 530 from the signal observed by either the fourth sensor 510 or the fifth sensor 520, the noise of the fourth sensor 510 and the fifth sensor 520 is observed to decrease by about ten decibels. The mathematical removal of noise from the fourth sensor 510 signal or the fifth sensor 520 signal using the sixth sensor 530 signal is optionally performed using on board electronics or in a post processing step, as described supra.

### Buoyancy

In any of the sensors 124 described herein, any of the layers, such as an outer buoyancy element are optionally configured with glass spheres, which function as a buoyancy element. Generally, the glass spheres are incompressible up to about two thousand pounds per square inch. Glass spheres are useful in maintenance of uniform buoyancy regardless of the depth at which the streamer 120 is towed. A preferred glass sphere has a density of about 0.32 g/cm³; however the glass spheres optionally have a density of less than water and/or less than about 0.9, 0.8, 0.7, 0.6, 0.5, 0.4, 0.3, or 0.2 g/cm³.

The buoyancy element, which is optionally the outer housing 126:
is optionally used with any sensor 124 herein;
optionally contains non-compressible glass spheres; and/or
optionally contains varying amounts of the glass spheres to adjust buoyancy as a function of x-axis position and/or as a function of streamer element size and density.

### Stacked Sensors

Optionally, two or more sensors, such as a motion sensor, acoustic sensor, and/or a turbulence sensor, are stacked along the y- and z-axes at a given point or length along the x-axis of the streamer cable 122. Generally, the stacked sensors includes any of the elements of the motion sensor. Similarly, the stacked sensors includes any of the elements of the acoustic sensor 300. Still further, generally the stacked sensor optionally includes non-acoustic sensors similar to the non-acoustic sensors 410, 430, and 530 described supra.

### Combined Sensors

For clarity, another example of a combined sensor is provided. While individual sensor sections are optionally placed in different positions relative to each other, the example uses:
a sensor accelerometer positioned on a substrate;
a first non-acoustic sensor positioned radially outward from a center of the substrate relative to the sensor accelerometer;
a second non-acoustic sensor positioned radially outward from a center of the substrate relative to the sensor accelerometer; and
an acoustic sensor positioned both radially outward from the center of the substrate relative to the sensor accelerometer and about adjacent to at least one of the first and second non-acoustic sensors.

Generally, the sensor accelerometer uses piezoelectric motion film between a metalized ink conductor on a first z-axis side, a second metalized ink conductor or conductive fluid in an enclosed chamber on a second z-axis side of the piezoelectric motion film. Any of the acoustic sensor elements described supra, such as the inner shoulders, diaphragm, and/or the edge constraints are optionally used.

Generally, the non-acoustic sensors are offset from the substrate using a rigid support, such as the outer shoulders. The non-acoustic sensors are attached without a substantial gap in rigid layers to the convex side of the substrate, such as through the outer shoulder and or through the rigid motion sensor housing circumferentially encompassing the sensor accelerometer. The one or more optional non-acoustic sensors are preferably located within about 1, 2, 3, 4, 5, 10, 15, or 20 centimeters of a sensor accelerometer and/or an acoustic sensor. Each of the one or more non-acoustic sensors include a piezoelectric film between two conductive layers, such as metalized ink layers.

Generally, an offset acoustic sensor uses any of the elements of the acoustic sensor 300. For example, the offset acoustic sensor includes a piezoelectric acoustic film 330 between conductive material on both the outer surface and the inner surface, as described supra. A set of flexible microspheres 320 or a pressure equalizing hollow cavity are positioned between a motion sensor housing and the inner layer 336 of the piezoelectric acoustic film 330. The outer surface 332 of the piezoelectric acoustic film 330 is optionally coated with a flexible solid.

Generally, the sensor accelerometer, non-acoustic sensor, and offset acoustic sensor are optionally positioned in any spatial position relative to each other. For example:
the offset acoustic sensor is optionally positioned radially outward from the non-acoustic sensor;
the non-acoustic sensor is optionally at a first radial distance away from the streamer cable 122 that is different than one or both of a second radial distance between the streamer cable 122 and the acoustic sensor or a third radial distance between the streamer cable and the sensor accelerometer; and/or
the sensor accelerometer, non-acoustic sensor, and offset acoustic sensor are vertically stacked.

Stacking of at least two of the sensor accelerometer, the non-acoustic sensor, and the offset acoustic sensor reduces the stiff length section(s) of the sensor array 120, which aids in durability and deployment of the sensor array 120.

A means of connecting the electrodes of the film is provided in which wires are attached to a means by which the signal can be passed through the outer shoulders of the assembly.

Rigid stress isolating blockers specifically designed to allow for the inner molding and attachment of the embodied sensors to the primary electromechanical cable are then molded to the ends of the innermost mandrel with conductive pins insert molded to allow for the passing of the dual sensor's respective outputs through the outer shoulders to the adjacent sensors and ultimately passing the signals to the core of the electromechanical cable. The shapes at the ends of the shoulder moldings are specifically configured to prevent the entrapment of air bubbles in the vertical inner molding process.

Each individual sensor embodiment is then over molded between the previously molded shoulders resident at the ends of the individual innermost mandrels to form a smooth shape suitable for secondary over molding with an elastomeric flexible syntactic flotation material.

### Streamer Cable

Completed sensor pairs are then arranged into a group of sensors that forms the acoustic, motion, and/or turbulence sensor apertures of the seismic streamer section.

The acoustic sensors 300 are typically combined electrically in parallel by use of a twisted pair of conductors connected from one sensor to the next with sufficient length so as to allow for the helix of the wire around the core cable between sensors to prevent breakage when the streamer is bent either in handling or in winding on a reel.

The motion sensors are typically combined electrically in parallel by use of a twisted pair of conductors connected from one sensor to the next with sufficient length so as to allow for the helix of the wire between sensors to prevent breakage when the streamer is bent either in handling or in winding on a reel.

The completed inner and outer molded sensor section is then over molded with a second form of glass spheres or glass microspheres loaded into an incompressible elastomeric flotation compound that creates a uniform diameter continuous flexible sensor section.

Optional relationships between sensor 124 components are further described:
The rigid mandrel or substrate forms the base of the sensor construction.
Features molded over the rigid substrate, such as the inner shoulders and outer shoulders form the necessary cavities and supporting structures to place the components of the dual sensors.
The polymer film motion sensor element resides between the inner shoulders and forms the cavity or hollow chamber into which an optional liquid metal electrode is placed.
The motion sensor shoulders reside beneath or adjacent to the acoustic sensor 300 shoulders.
The optional conductive material placed around the inner base of the cavity resides in contact with the liquid metal.
The second set of shoulders provides for the mounting of a second rigid tube, which forms a cylindrical cavity around the motion sensor element.
The second rigid tube forms the substrate for the acoustic sensor 300 element, which resides outside the circumference of the second rigid tube.
The second piezo-element 330 with its patterned syntactic loaded adhesive is then wrapped around the outer rigid substrate and forms the passive flow noise cancelling acoustic sensor 300.
The electrical wires from each respective sensor are attached together either in parallel or series to create a group of sensors that comprise a discreet channel within the seismic streamer 122.
The group of sensors are placed on the core cable by sliding the cable through the inner diameter of the sensor embodiment.
Acoustic output from the acoustic sensor 300 is wired separate and apart from acceleration output from the acceleration sensor and both sensors are presented to an opening in the inner electromechanical cable where they are attached to their respective pairs of wires within the core cable.
The discreet sensor embodiments are placed in a mold that presents the individual sensor embodiments to their desired locations within the group.
The group of sensors is then molded to the inner core cable with the novel shoulder shape of the individual embodiments preventing the entrapment of air bubbles during the molding process.
The cable is terminated with connectors located at each end. Each cable length comprises a section of the cable.
Each section of the cable is then presented to the process of over molding of the syntactic flotation material which completes the process of construction of the dual sensor seismic section with passive flow noise cancelling.

An example of how components work together is provided:
The first inner rigid substrate provides a rigid form that isolates mechanical energy present in the core electromechanical cable from both the motion sensor and the passive flow noise cancelling acoustic sensor 300.
The inner rigid substrate provides a rigid form upon which mechanical features are molded. The substrate is preferably a rigid filled plastic for ease of manufacture, that form the embodiment and form for both the motion and flow noise cancelling acoustic sensor 300 and the later molded rigid stress isolating, bubble eliminating outer shoulders.
A piezoelectric polymer film element is constructed where a single side of the film receives a conductive coating forming an electrode plate and wrapped about the shoulders present at the edge of the molded cavity that reside about the circumference of the molded form forming a sealed cavity about the circumference and between the outer diameter of the inner molded form and the inner diameter of the wrapped piezoelectric element where the metalized electrode resides on the outer diameter of the piezoelectric film.
A conductive element is wrapped a plurality of wraps about the outer diameter of the inner molded form to create an inner electrode conductive surface with one end presented through and outside the sealed chamber available to attach a conductor for signal transmission.
The motion sensor 300 is enclosed in a rigid tube, which prevents acoustic energy from contributing to the output of the piezoelectric motion sensor.
The second tube forms the mandrel upon which the acoustic element is constructed and isolates the acoustic sensor 300 from mechanical energy present in the core electro mechanical cable.
A second piezoelectric polymer element 330 is constructed and plated on both sides to create a piezoelectric element. The thin film piezoacoustic sensor 300 is created using a novel flexible microsphere loaded adhesive transfer material, which covers a specific area on one side of the plated film 330 along a length from the end equal to the circumference of the outer mandrel and positioned between two adjacent strips of non-sphere loaded transfer adhesive. Regions of the adhesive strip that are not coated with spheres continue over and above the remaining length of the piezo film. Beginning at the end of the piezopolymer film that is coated with the flexible microsphere loaded transfer adhesive, the PVDF piezopolymer thin film 330 is wrapped around the circumference of the mandrel a minimum of one single wrap or a plurality of wraps depending on the length of the piezoelectric acoustic film 330. While a single wrap minimum is specified, it is desirable to create a complex pattern of both filled and non filled transfer adhesive to create a fractal sampling pattern for both the acoustic sensor and the turbulent boundary sensor.
Electrical connection is made to the piezoelectric film by crimps that puncture the piezoelectric film and provide a conductive path to which wires are then attached to transmit the desired signal which is a common practice in terminating piezopolymer films.

### Sensor Function

Dynamic pressure, regardless of the source, results in a pressure differential to exist between the sealed volume of the microspheres 320 and the outside of the sensor resulting in a mechanical change in the piezopolymer acoustic film 330 that mirrors the dynamic change in pressure in that area. Turbulent boundary layer pressures present over the flexible microsphere loaded areas also result in an output proportional to the mechanical changes in the same manner and form as the acoustic pressures and are considered to be “in phase”. This is due to the way in which the film deforms and the respective response by the three axis of deformation in the PVDF film with d31, d32 and d33, d31 and d32 being electrically in phase with d33 being electrically out of phase by about one hundred eighty degrees. The deformation resulting from a positive change in dynamic pressure in the areas where the PVDF film is underlain by the compressible microspheres 320 results in the compression of the flexible microspheres 320, thus shortening the circumference of the cylinder of wrapped PVDF film. This shortening results in an output from the d31 axis, the axis of highest sensitivity to change, a shortening of the d32 axis results with it's minor contribution to the convolved output and constrained by Poison's ratio, there is a corresponding lengthening of the d33 axis or a thickening of the film. This action is mechanically out of phase with the other two axis which results in the signal output due to the change in the d33 to be in phase electrically with both d31 and d32. The convolution of these three outputs results in a pre-determined sensitivity to acoustic energy controlled by the mechanical deformation.

In the areas of the PVDF film where the transfer adhesive has no compressible microspheres, both the d31 and d32 axis of response are now constrained, unable to contribute effectively to dynamic pressure. The bounded condition present on d31 and d32 means that the films only available axis of response resides in the force present on the d33 axis. It can be understood that compression of the d33 axis results in a shortening of the d33 axis and a corresponding output resulting from that deformation is mechanically out of phase with the d33 axis response in those areas where compressible microspheres reside. It has been demonstrated that under these constrained conditions, the output from the d33 axis is some 40 dB lower than that from the d33 axis in the areas where compressible microspheres reside and about one hundred eighty degrees out of phase, thus subtracting from the acoustic output. The resulting signal due to acoustic pressure is reduced insignificantly. The pressure fields produced by the turbulent boundary layer manifest themselves as a force in the solid non-compressible microsphere 322 loaded flotation material which is over molded above the sensor and electro-mechanical cable, pressing down and into the non-sphere backed PVDF film resulting in a compression of the d33 axis of the PVDF film producing a corresponding output proportional to the forces present on the now incompressible PVDF film element which is also 180 degrees out of phase with the corresponding signal produced by the turbulent boundary layer in the areas under which the compressible microspheres lie, thus cancelling the signals due to turbulent boundary layer noise.

### Method of Manufacture

An example of method of manufacture is described.

To make the invention, a rigid mandrel or substrate is fabricated to produce a desired form factor for the final embodiment as a seismic streamer or sensor array 120. The substrate or rigid mandrel is over molded to place the required features onto the surface of the rigid mandrel to allow for the mounting and isolation of the two discreet sensors, such that the two sensors occupy the same space and are deemed co-located. The two sensors are optionally the motion sensor and acoustic sensor 300. The motion sensor is immune to acoustic energy by the placement of a rigid tube that surrounds the motion sensor and prevents sound from accessing the volume where the motion sensor resides. The rigid tube forms the substrate or base for the acoustic sensor 300. The acoustic sensor 300 is formed around the outer substrate with a flexible microsphere loaded adhesive resident beneath and between the film element and the rigid substrate. The film can be continuous or can be comprised of discreet patterns of electrodes deposited onto the surface of the polymer film to accomplish the desired response characteristics.

### Dual Element Sensors

A number of dual element sensors are electrically wired either in series or in parallel to form the desired group or aperture characteristics. Acoustic sensors are wired together providing one signal output and the acceleration sensors are wired together to provide a single signal output of acceleration. The embodiment of the group or aperture is optionally a set of elements spaced as close to one another as is mechanically practical preserving the ability to bend the aperture around a winch or sheave without damage while optimizing rejection of mechanical energy propagating along the length of the cable. The wired group is then loaded onto the core cable in the desired location by threading the core cable through the inner diameter of the combined sensor and electrically terminated to the core cable through a single opening in the core cable jacket.

The group of sensors is placed in the group mold which fixes the location of the individual sensors within the group and along the length of the entire cable; the wires interconnecting the individual elements within the group are wrapped in two directions about the core cable between the discreet locations within the group. The group is molded to the cable sealing the entrance of the wires into the core cable jacket eliminating potential leakage paths and centering the elements about the cable. Microsphere loaded solid flexible elastomer flotation is then molded over the entire cable length and over the individual groups having previously been mounted along the entire cable length.

The location of the motion sensor is optionally either beneath the acoustic sensor or adjacent to the acoustic sensor residing on the same rigid substrate. This allows for a reduced diameter of the entire embodiment as required. The spacing within the group between the discreet elements of the group is optionally varied depending of the desired response of the group with some elements spaced at one interval, some at another to tailor the response of the motion sensor to reject undesirable energy propagating within the streamer assembly essentially tuning the aperture to respond only to the desired vertically propagating signal.

The dual sensor within a seismic streamer operates with two objectives, reduction of noise due to flow and the recovery of bandwidth in the acoustic domain that is lost as a result of the energy that is propagating from the earth below, reflecting back from the sea surface and air interface, inverting and propagating down to the acoustic receivers in the streamer, thus interfering with the desired upward propagating signals causing a loss of signal within a bandwidth determined by the depth of tow relative to the reflected surface. Use of both an acoustic sensor and a motion sensor allows in post processing of the seismic data, the use of the inherent directional characteristics of motion to be convolved with the inherent characteristic lack of direction in acoustic signals to remove he downward propagating energy from the desired signals, thus recovering the lost energy and improving the resolution of the seismic data. Unlike other descriptions of this technique, this system provides that the motion and acoustic response from the discreet sensors result from the same excitation due to the co-location of the acoustic and motion sensors, allowing for improved processing results. The noise due to flow is reduced by placing a single continuous element where a portion of the element is bonded to the substrate using a flexible microsphere loaded adhesive which creates the acoustic sensing portion of the element. The remaining surface of the element is coated with a non sphere filled adhesive that bonds the polymer film directly to the surface of the rigid substrate, thus preventing its changing length due to acoustic energy and the associated change in the circumference of the microspheres residing beneath the film. The portion of the film with no microspheres responds with only one axis of deformation, that being the thickness axis, to the force created by the turbulence present at the surface of the flotation material which in the case of the area where the microspheres reside is unbounded and thus responds to the pressure. The force manifests itself out of phase with the pressure and thus the signal generated in a contiguous piece of PVDF thin film causes the two signals due to turbulent boundary layer flow noise to cancel, thus mitigating the overall response to this type of undesirable energy.

The use of these two distinct outputs from the differing sensors allows in data processing for the recovery of lost energy due to the reflections from above at the air water interface. In one embodiment, the current system places both the acoustic sensor 300 and motion sensor in the same physical space thus eliminating any differences in response due to their different location. The system also provides for a uni-axial accelerometer that only senses vertical and does so with no complex mechanical parts or gimbals and resides interior to the acoustic sensor. Co-locating the sensors results in a linear transfer function between the two sensors and simplifies and improves post processing. The dual output sensor utilizes acceleration so that proper phase is maintained between the acoustic response and the acceleration response.

In varying embodiments, the sensor 124 comprises any of:
a thin film piezopolymer acoustic sensor incorporating a flexible microsphere loaded transfer adhesive as the compressible gas chamber providing high sensitivity and immunity to overburden pressure;
a seismic streamer for marine seismic surveys embodying a thin film piezopolymer acoustic sensor incorporating a unique flexible microsphere loaded transfer adhesive as the compressible gas chamber providing high sensitivity and immunity to overburden pressure;
a thin film piezopolymer acoustic sensor incorporating a flexible microsphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow;
a seismic streamer for marine seismic surveys embodying a thin film piezo polymer acoustic sensor incorporating a unique flexible micro-sphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow;
a monolithic sensor or multiple sensors housed in a single housing, such as a rigid housing, dual output, flow noise cancelling acoustic and liquid metal uniaxial motion sensor embodied in a flexible elastomer, such as a syntactic elastomer, based solid seismic streamer for marine seismic surveys;
a seismic streamer for marine seismic surveys embodying a thin film piezo polymer acoustic sensor incorporating a flexible microsphere loaded transfer adhesive as the compressible gas chamber providing high sensitivity and near immunity to overburden pressure combined with zones of non-microsphere loaded transfer adhesive to act as sensors of the turbulent boundary layer whose combined output provides for passive cancelling of noise due to turbulent boundary layer flow;
a monolithic dual output, acoustic and motion sensor co-located within a single discreet housing;
a monolithic dual output, acoustic sensor and motion sensor utilizing an acoustic sensor employing a flexible piezopolymer film, such as a syntactic backed piezopolymer film embodiment;
a monolithic dual output, acoustic and motion sensor utilizing a liquid metal electrode arrangement, which uses gravity to place the fluid mass and electrode in such a manner as to allow for sensing only vertical motion and rejecting undesirable motion;
a monolithic dual output, acoustic and acceleration sensor utilizing a novel pressure isolation method to prevent acoustic response in the motion sensor response;
a seismic streamer for marine seismic surveys embodying a thin film piezo polymer acoustic sensor incorporating a flexible microsphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow combined with a novel monolithic dual output, acoustic and motion sensor utilizing a novel liquid metal electrode arrangement which uses gravity to place the fluid mass and electrode in such a manner as to allow for sensing only vertical motion and rejecting undesirable motion;
a monolithic dual output, acoustic and motion sensor embodied within a flexible syntactic seismic streamer in groups that are nested in complex spacing arrangements to enhance rejection of undesirable signals; and
a monolithic dual output, acoustic and motion sensor embodied within a flexible syntactic seismic streamer allowing for the core electro-mechanical cable to reside within the diameter of the sensor embodiment.

Still yet another embodiment includes any combination and/or permutation of any of the sensor elements described herein.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. An apparatus, comprising:
an acoustic piezoelectric sensor, comprising:
a rigid tube;
a flexible piezoelectric sensing element; and
a gap between an inner surface of said piezoelectric sensing element and said rigid tube; and
a first non-acoustic piezoelectric sensor within twenty centimeters of said acoustic piezoelectric sensor, said first non-acoustic piezoelectric sensor bonded directly to said rigid tube.

2. The apparatus of claim 1, wherein, except for said gap and any element therein, said non-acoustic piezoelectric sensor contains substantially similar elements as said acoustic piezoelectric sensor.

3. The apparatus of claim 1, further comprising:
a first zone of flexible microsphere loaded transfer adhesive proximately contacting said acoustic piezoelectric sensor, said first zone substantially filling said gap;
a second zone of non-microsphere loaded transfer adhesive proximately contacting said non-acoustic piezoelectric sensor, said second zone not directly contacting said first zone.

4. The apparatus of claim 1, said non-acoustic piezoelectric sensor directly electrically coupled to said acoustic piezoelectric sensor.

5. The apparatus of claim 1, further comprising at least one of:
electronics configured to remove at least a portion of a first output of said non-acoustic piezoelectric sensor from a second output of said acoustic piezoelectric sensor; and
a communication line configured to carry first output from said non-acoustic piezoelectric sensor and second output from said acoustic piezoelectric sensor to a processing system for post-processing, said communication line running through said rigid tube.

6. The apparatus of claim 1, said acoustic piezoelectric sensor further comprising:
an inner film surface contacting said flexible piezoelectric sensing element;
an outer film surface contacting said flexible piezoelectric sensing element;
a first conductive element contacting said outer film surface; and
a second conductive element contacting said inner film surface, said inner film surface proximate said gap.

7. The apparatus of claim 1, further comprising:
means for constraining motion of at least one of:
a y-y axis length of said flexible piezoelectric sensing element; and
a x-x axis width of said flexible piezoelectric sensing element.

8. The apparatus of claim 7, said means for constraining comprising any of:
an adhesive;
a bonding agent; and
a wrap.

9. The apparatus of claim 1, further comprising:
a second non-acoustic piezoelectric sensor circumferentially wrapped about said rigid tube within less than twenty centimeters of said acoustic piezoelectric sensor, said second non-acoustic piezoelectric sensor directly bonded to said rigid tube, said first non-acoustic piezoelectric sensor on a first side of said acoustic piezoelectric sensor, said second non-acoustic piezoelectric sensor on a second side of said acoustic piezoelectric sensor.

10. The apparatus of claim 1, said gap substantially filled with:
a plurality of flexible microspheres, said plurality of flexible microspheres proximate both:
said rigid tube; and
said flexible piezoelectric sensing element or a coating thereon.

11. The apparatus of claim 10, said plurality of microspheres configured as a compressible gas chamber responsive to pressure changes and substantially immune to overburden pressure in a marine deployed hydrophone sensing apparatus.

12. The apparatus of claim 10, said plurality of flexible microspheres comprising:
an average cross-sectional diameter of less than about one hundred micrometers.

13. The apparatus of claim 10, wherein a majority of said flexible microspheres each comprise:
a flexible plastic shell encompassing a sealed inner air chamber.

14. The apparatus of claim 10, said plurality of flexible microspheres configured to form a layer in said gap, said layer comprising an average thickness of less than about two millimeters.

15. The apparatus of claim 1, wherein said rigid tube further comprises:
a concave inner surface;
a convex outer surface; and
a channel in said convex outer surface at least partially circumferentially surrounding said rigid tube.

16. The apparatus of claim 15, further comprising:
a motion sensor, comprising:
a piezoelectric motion film circumferentially wrapped in the channel about said rigid hollow tube, said channel comprising a total volume between said rigid hollow tube and said piezoelectric motion film; and
a conductive liquid in the channel, said conductive liquid contacting both said rigid hollow tube and said piezoelectric motion film.

17. An apparatus, comprising:
an acoustic piezoelectric sensor; and
a non-acoustic piezoelectric sensor within twenty centimeters of said acoustic sensor; said acoustic piezoelectric sensor and said non-acoustic piezoelectric sensor configured to form a single output by directly wiring output of said non-acoustic piezoelectric sensor one hundred eighty degrees out of phase to output of said acoustic piezoelectric sensor.

18. The apparatus of claim 17, said acoustic piezoelectric sensor comprising at least one of:
a man made piezoelectric crystal;
a substantially lead free piezoceramic; and
a flexible film piezoelectric polymer, comprising:
an inner film surface and an outer film surface;
a first conductive element contacting said outer film surface; and
a second conductive element contacting said inner film surface.

19. The apparatus of claim 18, said polymer comprising:
a polyvinyl idene fluoride.

20. The apparatus of claim 18, said polymer comprising a strip of material, said material comprising:
an x-x width axis, said x-x width axis configured about parallel to a direction of towing of said apparatus;
a y-y length axis, wherein a constraining element restricts movement of said flexible film piezoelectric polymer along said y-y length axis; and
a z-z thickness axis electrically responsive to motion of said apparatus.

21. A method, comprising the steps of:
using an acoustic piezoelectric sensor in a marine towed sensor;
using a non-acoustic piezoelectric sensor within twenty centimeters of said acoustic sensor; and
combining outputs of said acoustic piezoelectric sensor and said non-acoustic piezoelectric sensor.

22. The method of claim 21, said acoustic piezoelectric sensor and said non-acoustic piezoelectric sensor responding with at least a ten decibel difference to a localized turbulence.
